(19) United States
(12) Patent Application Publication
(10) Pub. No.: US 2019/0027786 A1
(43) Pub. Date: Jan. 24, 2019

(54) Electrolyte Solution for Secondary Batteries, and Secondary Battery

(71) Applicant: NEC Corporation, Tokyo (JP)

(72) Inventors: Takehiro NOGUCHI, Tokyo (JP); Takuya HASEGAWA, Tokyo (JP); Shin SERIZAWA, Tokyo (JP)

(73) Assignee: NEC Corporation, Tokyo (JP)

(21) Appl. No.: 16/070,046

(22) PCT Filed: Jan. 12, 2017
(86) PCT No.: PCT/JP2017/000795

§ 371 Date: Jul. 13, 2018

(30) Foreign Application Priority Data
Jan. 15, 2016 (JP) 2016-006403
Sep. 15, 2016 (JP) 2016-180385

(51) Int. Cl. H01M 10/0569; H01M 10/0525; H01M 10/0567; H01M 4/505; H01M 4/525; H01M 4/58

(52) U.S. Cl. CPC H01M 10/0569; H01M 10/0525; H01M 4/58; H01M 4/505; H01M 4/525; H01M 10/0567

(57) ABSTRACT

The purpose of the present embodiment is to provide a lithium secondary battery which is assumed to be operated at a high voltage or to be used at high temperatures for a long period of time, and which has improved life characteristics by suppressing a decomposition reaction of the electrolyte solution. The present embodiment relates to an electrolyte solution for a secondary battery containing a sulfone compound, a fluorine containing ether and an acid anhydride at a specific composition, and a secondary battery which uses this electrolyte solution for a secondary battery.

### TECHNICAL FIELD

The present invention relates to an electrolyte solution, a secondary battery with the electrolyte solution, preferably a lithium ion secondary battery, and a method for manufacturing these.

### BACKGROUND ART

Lithium ion secondary batteries are widely used in notebook-type personal computers, mobile phones and the like, but they have problems with lifetime characteristics at high temperature and the like.

Lithium ion secondary batteries are widely used for various applications and it is necessary for the lithium ion secondary battery to maintain its life characteristics within a wide usable temperature range. In addition, batteries having a higher energy density than conventional batteries are required. One means to increase the energy density is to raise the operating voltage of the battery, but it is required to maintain equivalent lifetime characteristics even at high voltage.

During higher voltage operation than before, a decomposition reaction of the electrolytic solution tends to proceed at the contact portion between the positive electrode and the electrolyte solution. Especially at high temperature, the decomposition reaction causes reduction in capacity and gas generation due to decomposition products of the electrolytic solution. Since the gas generation raises the internal pressure of a cell and causes expansion of a cell, and therefore, it becomes a problem in practical use. For this reason, development of an electrolytic solution having high withstand voltage and high durability at high temperature is desired. Fluorinated solvents are considered as the electrolyte solution having high withstand voltage. Candidates for these include fluorinated carbonates, fluorinated carboxylic acid esters, fluorine-containing ethers, fluorine-containing phosphate esters and the like. Since the fluorinated solvents have low compatibility with other electrolyte solvents and high viscosity, it is impossible to obtain satisfactory lifetime characteristics and the effect of reducing gas generation without optimizing the formulation of the electrolytic solution. From this viewpoint, selection of electrolyte solvent, additive and solvent composition is important for improving battery characteristics. In addition, even when these fluorinated solvents are used, the decomposition of the solvents may proceed at the interface with the electrode in some cases. Various electrolyte solution additives have been studied to cope with such a decomposition reaction. Patent Document 1 discloses an electrolytic solution containing a fluorine-containing ether, an acid anhydride, a cyclic carboxylic acid ester and the like, but further improvement is required for the lifetime characteristics. Patent Document 2 and Patent Document 3 disclose that an electrolyte solution containing a fluorine-containing ether and an alkanesulfonic acid anhydride improves the life characteristics. However, these techniques alone are insufficient for batteries operating at high voltage and further improvement is necessary.

### CITATION LIST

### Patent Document

Patent Document 1: Japanese patent laid-open No. 2015-69704

Patent Document 2: Japanese patent No. 4968614

Patent Document 3: Japanese patent No. 4968615

### SUMMARY OF INVENTION

### Technical Problem

As described above, even when the electrolyte solution disclosed in each of Patent Documents 1 to 3 is used, a battery operating at high voltage cannot have sufficient cycle characteristics, and there still have been a problem that the capacity of the battery gradually decreases as charge and discharge cycles are repeated. Therefore, an object of the present invention is to provide an electrolyte solution for a secondary battery capable of further improving the life of the secondary battery comprising a positive electrode active material that operates at high potential.

### Solution to Problem

The electrolyte solution for a secondary battery according to the present invention is characterized in comprising an electrolyte solvent comprising at least one selected from open chain sulfone compounds represented by formula (1) and at least one selected from fluorine-containing ether compounds represented by formula (2), and at least one selected from acid anhydride compounds, wherein the amount of the open chain sulfone compound represented by formula (1) in the electrolyte solvent is more than 10 vol % and less than 70 vol %, the amount of the fluorine-containing ether compound represented by formula (2) in the electrolyte solvent is 30 vol % or more and 90 vol % or less, and the amount of the acid anhydride compound in the electrolyte solution is 0.1 mass % or more and 10 mass % or less.

R₁″—SO₂—R₂″ (1)

(R₀″ and R₂″ each independently represent substituted or unsubstituted alkyl group having 1 to 6 carbon atoms.)

R₁—O—R₂ (2)

(R₁ and R₂ each independently represent alkyl group having 1 to 7 carbon atoms, and at least one of R₁ and R₂ is fluorine-containing alkyl group.)

### Advantageous Effect of Invention

By using the electrolytic solution for a secondary battery of the present invention, it is possible to provide a secondary battery having high energy density and high life characteristics.

### BRIEF DESCRIPTION OF DRAWING

FIG. 1 is a cross-sectional view showing an example of a secondary battery of the present invention.

FIG. 2 is an exploded perspective view showing a basic structure of a film package battery.

FIG. 3 is a cross-sectional view schematically showing a cross section of the battery of FIG. 2.

### DESCRIPTION OF EMBODIMENTS

### <Electrolyte Solution for a Secondary Battery>

Preferable embodiments of the electrolyte solution for a secondary battery according to the present invention will be described below.

In the present embodiment, the electrolyte solution for a secondary battery comprises at least one selected from open chain sulfone compounds represented by the following general formula (1).

R₁″—SO₂—R₂″ (1)

(R₁″ and R₂″ each independently represent substituted or unsubstituted alkyl group.)

In formula (1), the carbon number n1 of R₁″ and the carbon number n2 of R₂″ are each independently and preferably 1≤n1≤6 and 1≤n2≤6, more preferably 1≤n1≤5 and 1≤n2≤5, and further preferably 1≤n1≤4 and 1≤n2≤4. The alkyl group includes linear alkyl group and branched alkyl group.

At least a part of hydrogens in the alkyl groups represented by R₁″ and R₂″ may be substituted with a halogen atom (for example, a chlorine atom, a bromine atom, a fluorine atom).

The open chain sulfone compound is not particularly limited, but examples thereof include dimethyl sulfone, ethyl methyl sulfone, diethyl sulfone, butyl methyl sulfone, dibutyl sulfone, methyl isopropyl sulfone, diisopropyl sulfone, methyl tert-butyl sulfone, butyl ethyl sulfone, butyl propyl sulfone, butyl isopropyl sulfone, di-tert-butyl sulfone, diisobutyl sulfone, ethyl isopropyl sulfone, ethyl isobutyl sulfone, tert-butyl ethyl sulfone, propyl ethyl sulfone, isobutyl isopropyl sulfone, butyl isobutyl sulfone and isopropyl (1-methyl-propyl) sulfone. Among these, at least one selected from dimethyl sulfone, ethyl methyl sulfone, diethyl sulfone, methyl isopropyl sulfone, and ethyl isopropyl sulfone is preferred because the molecular weight is small and the viscosity of the solvent is low.

These open chain sulfone compounds may be used singly or in combination of two or more thereof.

The open chain sulfone compound is used as an electrolyte solvent. The open chain sulfone compounds have a characteristic that the dielectric constant is comparatively high, facilitate dissociation of the electrolyte supporting salt and has the effect of increasing the electrical conductivity of the electrolyte solution. Also, the open chain sulfone compounds have characteristics that oxidation resistance is high and gas is less generated even at a high temperature operation. On the other hand, since the open chain sulfone compounds have high viscosity, if the concentration thereof is excessively high, ion conductivity conversely decreases and the open chain sulfone compounds precipitate in the electrolytic solution in some cases. For this reason, the content of the open chain sulfone compound in the electrolyte solvent is more than 10 vol % and less than 70 vol %, preferably 15 vol % or more and 65 vol % or less, and further preferably 20 vol % or more and 60 vol % or less. The open chain sulfone compounds have a characteristic that the compatibility with a solvent such as a fluorine-containing ether compound is high. When the open chain sulfone compound in the electrolyte solvent is contained in an amount of more than 10 vol %, the compatibility with a solvent such as a fluorine-containing ether compound can be enhanced.

In the present embodiment, the electrolyte solution for a secondary battery comprises at least one selected from fluorine-containing ether compounds represented by the following general formula (2).

R₁—O—R₂ (2)

(R₁ and R₂ each independently represent alkyl group, and at least one of R₁ and R₂ is fluorine-containing alkyl group. R₁ and R₂ each independently and preferably have 1 to 7 carbon atoms and more preferably 1 to 5 carbon atoms. The alkyl group includes straight-chain and branched-chain ones.)

The fluorine-containing ether compound may be used singly or in combination of two or more thereof.

Examples of the fluorine-containing ether compound include 2,2,3,3,3-pentafluoropropyl 1,1,2,2-tetrafluoroethyl ether, 1,1,2,2-tetrafluoroethyl 2,2,2-trifluoroethyl ether, 1H,1H,2′H,3H-decafluorodipropyl ether, 1,1,2,3,3,3-hexafluoropropyl-2,2-difluoroethyl ether, isopropyl 1,1,2,2-tetrafluoroethyl ether, propyl 1,1,2,2-tetrafluoroethyl ether, 1,1,2,2-tetrafluoroethyl 2,2,3,3-tetrafluoropropyl ether, 1H,1H,5H-perfluoropentyl-1,1,2,2-tetrafluoroethyl ether, 1H-perfluorobutyl-1H-perfluoroethyl ether, methyl perfluoropentyl ether, methyl perfluorohexyl ether, methyl 1,1,3,3,3-pentafluoro-2-(trifluoromethyl)propyl ether, 1,1,2,3,3,3-hexafluoropropyl 2,2,2-trifluoroethyl ether, ethyl nonafluorobutyl ether, ethyl 1,1,2,3,3,3-hexafluoropropyl ether, 1H,1H,5H-octafluoropentyl 1,1,2,2-tetrafluoroethyl ether, 1H,1H,2′H-perfluorodipropyl ether, heptafluoropropyl 1,2,2,2-tetrafluoroethyl ether, methyl nonafluorobutyl ether, 1,1-difluoroethyl-2,2,3,3-tetrafluoropropyl ether, bis(2,2,3,3-tetrafluoropropyl) ether, 1,1-difluoroethyl-2,2,3,3,3-pentafluoropropyl ether, 1,1-difluoroethyl-1H,1H-heptafluorobutyl ether, 2,2,3,4,4,4-hexafluorobutyl-difluoromethyl ether, bis(2,2,3,3,3-pentafluoropropyl) ether, nonafluorobutyl methyl ether, bis(1H,1H-heptafluorobutyl) ether, 1,1,2,3,3,3-hexafluoropropyl-1H,1H-heptafluorobutyl ether, 1H,1H-heptafluorobutyl-trifluoromethyl ether, 2,2-difluoroethyl-1,1,2,2-tetrafluoroethyl ether, bis(trifluoroethyl) ether, bis(2,2-difluoroethyl) ether, bis(1,1,2-trifluoroethyl) ether and 1,1,2-trifluoroethyl-2,2,2-trifluoroethyl ether.

Among these, from the viewpoint of the voltage resistance, the boiling point and the like, preferable are at least one selected from 1,1,2,2-tetrafluoroethyl-2,2,3,3-tetrafluoropropyl ether, 2,2,3,4,4,4-hexafluorobutyl-difluoromethyl ether, 1,1-difluoroethyl-2,2,3,3-tetrafluoropropyl ether, 1,1,2,3,3,3-hexafluoropropyl-2,2-difluoroethyl ether, 1,1-difluoroethyl-1H,1H-heptafluorobutyl ether, 1H,1H,2′H,3H-decafluorodipropyl ether, bis(2,2,3,3,3-pentafluoropropyl) ether, 1H,1H,5H-perfluoropentyl-1,1,2,2-tetrafluoroethyl ether, bis(1H,1H-heptafluorobutyl) ether, 1H,1H,2′H-perfluorodipropyl ether, 1,1,2,3,3,3-hexafluoropropyl-1H,1H-heptafluorobutyl ether, and 1H-perfluorobutyl-1H-perfluoroethyl ether.

The fluorine-containing ether compound is used as an electrolyte solvent, in combination with the open chain sulfone compound. The fluorine-containing ether compounds have a problem of the compatibility with other solvents being low, but by adding the open chain sulfone compound, the compatibility between the solvents can be raised. The fluorine containing ether compounds have high oxidation resistance and are useful as an electrolyte solvent for a battery having a positive electrode active material that operates at a high potential. However, since the solubility of supporting salts and the compatibility with other solvents are low, if the concentration is too high, it is difficult to obtain a uniform electrolyte solution. In view of these points, the volume ratio of the fluorine-containing ether compound in the electrolyte solvent is 30 vol % or more and 90 vol % or less, preferably 35 vol % or more and 85 vol % or less, and more preferably 40 vol % or more and 80 vol % or less.

The same effect can be obtained even when the electrolyte solvent comprises a solvent other than the open chain sulfone compound and the fluorine-containing ether compound in a small amount, but since the open chain sulfone compound and the fluorine-containing ether compound have high oxidation resistance and can maintain the life characteristics of the battery in a high level, it is preferable that these are main constituents. The total volume ratio of the open chain sulfone compound and the fluorine-containing ether compound in the electrolyte solvent is preferably 80 vol % or more, more preferably 85 vol % or more and further more preferably 90 vol % or more, and may be 100 vol %.

The solvents other than the open chain sulfone compound and the fluorine-containing ether compound include cyclic carbonates (including fluorinated ones), open chain carbonates (including fluorinated ones), open chain carboxylic acid esters (including fluorinated ones), cyclic carboxylic acid esters (including fluorinated ones), cyclic ethers (including fluorinated ones), phosphate esters (including fluorinated ones), cyclic sulfone compounds and the like.

The cyclic carbonate is not especially limited, but examples thereof include ethylene carbonate (EC), propylene carbonate (PC), butylene carbonate (BC) and vinylene carbonate (VC). Examples of the fluorinated cyclic carbonate include compounds prepared by substituting a part or the whole of hydrogen atoms of ethylene carbonate (EC), propylene carbonate (PC), butylene carbonate (BC), vinylene carbonate (VC) or the like with a fluorine atom(s). As the fluorinated cyclic carbonates, there can be used, more specifically, for example, 4-fluoro-1,3-dioxolan-2-one (monofluoroethylene carbonate), (cis- or trans-)4,5-difluoro-1,3-dioxolan-2-one, 4,4-difluoro-1,3-dioxolan-2-one and 4-fluoro-5-methyl-1,3-dioxolan-2-one. The cyclic carbonate is, among those listed in the above, from the viewpoint of voltage resistance and conductivity, preferably ethylene carbonate, propylene carbonate, or 4-fluoro-1,3-dioxolan-2-one. The cyclic carbonate can be used singly or concurrently in two or more.

The open chain carbonate is not especially limited, but examples thereof include dimethyl carbonate (DMC), ethyl methyl carbonate (EMC), diethyl carbonate (DEC) and dipropyl carbonate (DPC). Further, the open chain carbonate includes fluorinated open chain carbonates. Examples of the fluorinated open chain carbonate include compounds prepared by substituting a part or the whole of hydrogen atoms of ethyl methyl carbonate (EMC), dimethyl carbonate (DMC), diethyl carbonate (DEC), dipropyl carbonate (DPC) or the like with a fluorine atom(s). More specific examples of the fluorinated open chain carbonate include bis(fluoroethyl) carbonate, 3-fluoropropyl methyl carbonate and 3,3,3-trifluoropropyl methyl carbonate. The open chain carbonate can be used singly or concurrently in two or more.

The open chain carboxylic acid ester is not especially limited, but examples thereof include ethyl acetate, methyl propionate, ethyl formate, ethyl propionate, methyl butyrate, ethyl butyrate, methyl acetate and methyl formate. The carboxylic acid esters further include fluorinated carboxylic acid esters, and examples thereof include compounds prepared by substituting a part or the whole of hydrogen atoms of ethyl acetate, methyl propionate, ethyl formate, ethyl propionate, methyl butyrate, ethyl butyrate, methyl acetate and methyl formate with a fluorine atom(s). These compounds are, for example, ethyl pentafluoropropionate, ethyl 3,3,3-trifluoropropionate, methyl 2,2,3,3-tetrafluoropropionate, 2,2-difluoroethyl acetate, methyl heptafluoroisobutyrate, methyl 2,3,3,3-tetrafluoropropionate, methyl pentafluoropropionate, methyl 2-(trifluoromethyl)-3,3,3-trifluoropropionate, ethyl heptafluorobutyrate, methyl 3,3,3-trifluoropropionate, 2,2,2-trifluoroethyl acetate, isopropyl trifluoroacetate, tert-butyl trifluoroacetate, ethyl 4,4,4-trifluorobutyrate, methyl 4,4,4-trifluorobutyrate, butyl 2,2-difluoroacetate, ethyl difluoroacetate, n-butyl trifluoroacetate, 2,2,3,3-tetrafluoropropyl acetate, ethyl 3-(trifluoromethyl)butyrate, methyl tetrafluoro-2-(methoxy)propionate, 3,3,3-trifluoropropyl 3,3,3-trifluoropropionate, methyl difluoroacetate, 2,2,3,3-tetrafluoropropyl trifluoroacetate, 1H,1H-heptafluorobutyl acetate, methyl heptafluorobutyrate and ethyl trifluoroacetate. Among these, from the viewpoint of voltage resistance, boiling point and the like, preferable are ethyl propionate, methyl acetate, methyl 2,2,3,3-tetrafluoropropionate, 2,2,3,3-tetrafluoropropyl trifluoroacetate and the like. The open chain carboxylic acid ester can be used singly or concurrently in two or more.

The cyclic carboxylic acid ester is not especially limited, but preferable are, for example, γ-lactones such as γ-butyrolactone, α-methyl-γ-butyrolactone and 3-methyl-γ-butyrolactone, β-propiolactone, and δ-valerolactone. Fluorinated ones thereof may be used. The cyclic carboxylic acid ester can be used singly or concurrently in two or more.

The cyclic ether is not especially limited, but preferable are, for example, 1,3-dioxolane, tetrahydrofuran, and 4-methyl-1,3-dioxolane. Also, fluorinated ones, such as 2,2-bis(trifluoromethyl)-1,3-dioxolane, are allowed to be used. The cyclic ether can be used singly or concurrently in two or more.

Examples of the phosphate ester include trimethyl phosphate, triethyl phosphate and tributyl phosphate.

Fluorine-containing phosphate ester may be also used. Examples of the fluorine-containing phosphate ester include 2,2,2-trifluoroethyl dimethyl phosphate, bis(trifluoroethyl) methyl phosphate, bistrifluoroethyl ethyl phosphate, tris(trifluoromethyl) phosphate, pentafluoropropyl dimethyl phosphate, heptafluorobutyl dimethyl phosphate, trifluoroethyl methyl ethyl phosphate, pentafluoropropyl methyl ethyl phosphate, heptafluorobutyl methyl ethyl phosphate, trifluoroethyl methyl propyl phosphate, pentafluoropropyl methyl propyl phosphate, heptafluorobutyl methyl propyl phosphate, trifluoroethyl methyl butyl phosphate, pentafluoropropyl methyl butyl phosphate, heptafluorobutyl methyl butyl phosphate, trifluoroethyl diethyl phosphate, pentafluoropropyl diethyl phosphate, heptafluorobutyl diethyl phosphate, trifluoroethyl ethyl propyl phosphate, pentafluoropropyl ethyl propyl phosphate, heptafluorobutyl ethyl propyl phosphate, trifluoroethyl ethyl butyl phosphate, pentafluoropropyl ethyl butyl phosphate, heptafluorobutyl ethyl butyl phosphate, trifluoroethyl dipropyl phosphate, pentafluoropropyl dipropyl phosphate, heptafluorobutyl dipropyl phosphate, trifluoroethyl propyl butyl phosphate, pentafluoropropyl propyl butyl phosphate, heptafluorobutyl propyl butyl phosphate, trifluoroethyl dibutyl phosphate, pentafluoropropyl dibutyl phosphate, heptafluorobutyl dibutyl phosphate, tris(2,2,3,3-tetrafluoropropyl) phosphate, tris(2,2,3,3,3-pentafluoropropyl) phosphate, tris(2,2,2-trifluoroethyl) phosphate, tris(1H,1H-heptafluorobutyl) phosphate and tris(1H,1H,5H-octafluoropentyl) phosphate. The phosphate ester can be used singly or concurrently in two or more.

The cyclic sulfone compound is not especially limited, but examples thereof include sulfolane (i.e. tetramethylene sulfone), methylsulfolanes such as 3-methylsulfolane, 3,4-dimethylsulfolane, 2,4-dimethylsulfolane, trimethylene sulfone (thietane 1,1-dioxide), 1-methyl trimethylene sulfone, pentamethylene sulfone, hexamethylene sulfone and ethylene sulfone. The cyclic sulfone compound can be used singly or concurrently in two or more.

In addition to the above, the following solvents may be contained as solvents in the electrolyte solution for a secondary battery. Examples thereof include dimethylsulfoxide, formamide, acetamide, dimethylformamide, acetonitrile, propionitrile, nitromethane, ethyl monoglyme, trimethoxymethane, 1,3-dimethyl-2-imidazolidinone, 3-methyl-2-oxazolidinone, 1,3-propane sultone, anisole, N-methyl pyrrolidone, cyclic disulfone compound, nitrile-based materials, boron-based materials and the like.

The electrolyte solution for a secondary battery according to the present invention further comprises an acid anhydride compound as an electrolyte additive. It is considered that the acid anhydride compound in the electrolytic solution has an effect of suppressing the volume expansion of the battery due to charging and discharging by forming a reaction product on the electrode as well as an effect of improving the lifetime characteristics. The open chain sulfone compounds have high reactivity with the electrodes during operation of the battery. However, it is considered that the acid anhydride compound forms a reaction product on the electrodes to suppress a reaction between the open chain sulfone compound and the electrode during operation of the battery, and therefore, the life characteristics of the battery comprising the open chain sulfone compound is improved. Although it is reasoning, it is thought that the acid anhydride compound traps moisture in the electrolyte solution, and therefore has an effect of suppressing gas generation caused by moisture.

As the acid anhydride compounds, carboxylic acid anhydrides, sulfonic acid anhydrides, and carboxylic sulfonic anhydride are exemplified.

Examples of the acid anhydride compound include open chain acid anhydrides represented by the following formula (3) and cyclic acid anhydrides represented by the following formula (4).

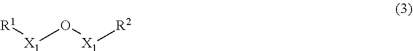

(In formula (3),

two X₁ are each independently carbonyl group (—C(═O)—) or sulfonyl group (—S(═O)₂—); and

R¹ and R² are each independently alkyl group having 1 to 10 carbon atoms, alkenyl group having 2 to 10 carbon atoms, cycloalkyl group having 3 to 10 carbon atoms, aryl group having 6 to 18 carbon atoms or arylalkyl group having 7 to 20 carbon atoms, and at least one of hydrogen atoms in R¹ and R² may be substituted with a halogen atom(s).)

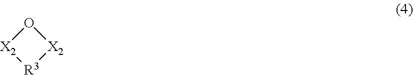

(in formula (4),

two X₂ are each independently carbonyl group (—C(═O)—) or sulfonyl group (—S(═O)₂—); and

R³ is alkylene group having 1 to 10 carbon atoms, alkenylene group having 2 to 10 carbon atoms, arylene group having 6 to 12 carbon atoms, cycloalkylene group having 3 to 12 carbon atoms, cycloalkenylene group having 3 to 12 carbon atoms or heterocycloalkylene group having 3 to 10 carbon atoms, and at least one of hydrogen atoms in R³ may be substituted with a halogen atom(s).)

The group represented by R¹ R² or R³ in the formula (3) and (4) will be described below.

In formula (3), the alkyl group and alkenyl group respectively may be a straight chain or may have a branched chain, and the number of carbon atoms is generally 1 to 10, preferably 1 to 8, and more preferably 1 to 5.

In formula (3), the number of carbon atoms of the cycloalkyl group is preferably 3 to 10, and more preferably 3 to 6.

In formula (3), the number of carbon atoms of the aryl group is preferably 6 to 18, and more preferably 6 to 12. Examples of the aryl group include phenyl group, naphthyl group, and the like.

In formula (3), the number of carbon atoms of the arylalkyl group is preferably 7 to 20, and more preferably 7 to 14. Examples of the arylalkyl group include benzyl group, phenylethyl group, naphthylmethyl group, and the like.

In formula (3), R¹ and R² are each independently more preferably an alkyl group having 1 to 3 carbon atoms or phenyl group.

In formula (4), the alkylene group and the alkenylene group respectively may be a straight chain or may have a branched chain, and the number of carbon atoms is generally 1 to 10, preferably 1 to 8, and more preferably 1 to 5.

In formula (4), the number of carbon atoms of the arylene group is preferably 6 to 20, and more preferably 6 to 12. Examples of the arylene group include phenylene group, naphthylene group, biphenylene group and the like.

In formula (4), the number of carbon atoms of the cycloalkylene group is typically 3 to 12, preferably 3 to 10 and more preferably 3 to 8. The cycloalkylene group may be monocyclic or may have a plurality of ring structures like bicycloalkylene group.

In formula (4), the number of carbon atoms of the cycloalkenylene group is typically 3 to 12, preferably 3 to 10 and more preferably 3 to 8. The cycloalkenylene group may be monocyclic or may have a plurality of ring structures, at least one of which has an unsaturated bond, like bicycloalkenylene group. Examples of the cycloalkenylene group include divalent groups formed from cyclohexene, bicyclo[2.2.1]heptene, bicyclo[2.2.2]octane and the like.

In formula (4), the heterocycloalkylene group denotes a divalent group in which at least one of carbon atoms on the ring of the cycloalkylene group is replaced with one, two or more hetero atoms such as sulfur, oxygen and nitrogen. The heteroalkylene group is preferably 3 to 10-membered ring, more preferably 4 to 8-membered ring, and furthermore preferably 5- or 6-membered ring.

In formula (4), R³ is more preferably alkylene group having 1 to 3 carbon atoms, alkenylene group having 2 or 3 carbon atoms, cyclohexylene group, cyclohexenylene group or phenylene group.

The acid anhydride compound may be halogenated partly. Examples of the halogen atom include chlorine, iodine, bromine, fluorine and the like. Among these, chlorine and fluorine are preferred, and fluorine is more preferred.

The acid anhydride compound represented by formula (3) or (4) may have a substituent other than halogen atoms. Examples of the substituent include alkyl group having 1 to 5 carbon atoms, alkenyl group having 2 to 5 carbon atoms, alkoxy group having 1 to 5 carbon atoms, aryl group having 6 to 12 carbon atoms, amino group, carboxy group, hydroxy group, and cyano group, and the like, but are not limited to these. For example, at least one of hydrogen atoms in the saturated or unsaturated hydrocarbon ring contained in R¹, R² or R³ may be substituted with an alkyl group having 1 to 3 carbon atoms.

Among them, the acid anhydride compound is preferably a carboxylic acid anhydride having a structure represented by [—(C═O)—O—(C═O)—] in the molecule. Examples of the carboxylic acid anhydride include open chain carboxylic acid anhydrides represented by the following formula (5) and cyclic carboxylic acid anhydrides represented by the following formula (6).

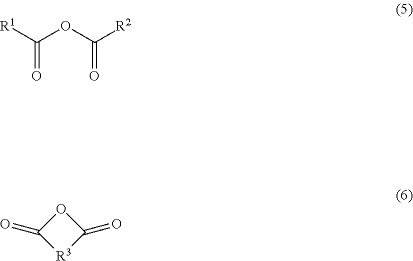

Herein, groups represented by R¹, R² and R³ in formulae (5) and (6) are the same as those exemplified in the above formulae (3) and (4).

Preferred compound examples of the carboxylic acid anhydride include acetic anhydride, maleic anhydride, phthalic anhydride, propionic anhydride, succinic anhydride, benzoic anhydride, glutaric anhydride, difluoroacetic anhydride, 3H-perfluoropropionic anhydride, 3,3,3-trifluropropionic anhydride, pentafluoropropionic anhydride, 2,2,3,3,4,4-hexafluoropentanedioic anhydride, tetrafluorosuccinic anhydride, trifluoroacetic anhydride, hexafluoroglutaric anhydride, 4-methylphthalic anhydride and the like.

Examples of the carboxylic acid anhydride include open chain acid anhydrides such as acetic anhydride, propionic anhydride, butyric anhydride, crotonic anhydride and benzoic anhydride; and acid anhydrides having a cyclic structure (cyclic acid anhydrides) such as succinic anhydride, glutaric anhydride, maleic anhydride, phthalic anhydride, 5,6-dihydroxy-1,4-dithiin-2,3 dicarboxylic anhydride, 5-norbornene-2,3-dicarboxylic anhydride, 1,2,3,6-tetrahydrophthalic anhydride, bicyclo[2.2.2]oct-5-ene-2,3-dicarboxylic anhydride and the like.

Examples of the halogenated carboxylic acid anhydride include difluoroacetic anhydride, 3H-perfluoropropanoic anhydride, 3,3,3-trifluoropropionic anhydride, pentafluoropropionic anhydride, 2,2,3,3,4,4-hexafluoropentanedioic anhydride, tetrafluoro succinic anhydride, trifluoroacetic anhydride, hexafluoroglutaric anhydride and the like. In addition to halides, an acid anhydride having another substituent, such as 4-methylphthalic anhydride, may also be used.

Examples of the sulfonic anhydride include open chain sulfonic anhydrides such as methanesulfonic anhydride, ethanesulfonic anhydride, propanesulfonic anhydride, butanesulfonic anhydride, pentanesulfonic anhydride, hexanesulfonic anhydride, vinylsulfonic anhydride, benzenesulfonic anhydride; cyclic sulfonic anhydrides such as 1,2-ethanedisulfonic anhydride, 1,3-propanedisulfonic anhydride, 1,4-butanedisulfonic anhydride, 1,2-benzenedisulfonic anhydride; and halogenated compounds thereof.

Examples of the carboxylic sulfonic anhydride include open chain carboxylic sulfonic anhydrides such as methanesulfonic acetic anhydride, ethanesulfonic acetic anhydride, propanesulfonic acetic anhydride, methanesulfonic propanoic anhydride, ethanesulfonic propanoic anhydride, propanesulfonic propanoic anhydride; cyclic carboxylic sulfonic anhydrides such as 3-sulfopropionic anhydride, 2-methyl-3-sulfopropionic anhydride, 2,2-dimethyl-3-sulfopropionic anhydride, 2-ethyl-3-sulfopropionic anhydride, 2,2-diethyl-3-sulfopropionic anhydride, 2-sulfobenzoic anhydride; and halogenated compounds thereof.

The content of the acidic anhydride compound in the electrolyte solution is preferably 0.1 mass % or more and 10 mass % or less, more preferably 0.2 mass % or more and 8 mass % or less, and further preferably 0.5 mass % or more and 5 mass % or less. When the content of the acid anhydride compound in the nonaqueous electrolyte solution is 0.1 mass % or more, an effect of enhancing capacity retention ratio can be obtained, and moreover, an effect of suppressing the gas generation due to decomposition of the electrolyte solution can be obtained. The content of the acid anhydride compound in the electrolyte solution is preferably 0.1 mass % or more, more preferably 0.2 mass % or more, and most preferably 0.5 mass % or more. When the content of the acid anhydride in the electrolyte solution is 10 mass % or less, it is possible to maintain good capacity retention ratio and also possible to suppress the gas generation due to decomposition of the acid anhydride. The content of the acid anhydride compound in the electrolyte solution is preferably 10 mass % or less, more preferably 8 mass % or less, and most preferably 5 mass % or less.

Examples of a supporting salt include lithium salts such as LiPF₆, LiAsF₆, LiAlCl₄, LiClO₄, LiBF₄, LiSbF₆, LiCF₃SO₃, LiC₄F₉SO₃, LiC(CF₃SO₂)₂, LiN(FSO₂)₂ (LiFSI), LiN(CF₃SO₂)₂, LiN(C₂F₅SO₂)₂, LiB₁₀Cl₁₀. In addition, the supporting salt includes lower aliphatic lithium carboxylate, chloroboran lithium, lithium tetraphenylborate, LiBr, LiI, LiSCN, LiCl and the like. Among them, LiPF₆ and LiFSI are especially preferred from the viewpoint of oxidation resistance, reduction resistance, stability, and ease of dissolution. The supporting salt may be used alone or in combination of two or more. The concentration of the supporting salt is preferably 0.3 mol/l or more and 5 mol/l or less, more preferably 0.4 mol/l or more and 4 mol/l or less, and most preferably 0.5 mol/l or more and 3 mol/l or less, based on the total volume of the electrolyte solvent.

An ion-conductive polymer can further be added to the electrolyte solution for a secondary battery. Examples of the ion-conductive polymer include polyethers such as polyethylene oxide and polypropylene oxide, and polyolefins such as polyethylene and polypropylene. As the ion-conductive polymer, there can further be used, for example, polyvinylidene fluoride, polytetrafluoroethylene, polyvinyl fluoride, polyvinyl chloride, polyvinylidene chloride, polymethyl methacrylate, polymethyl acrylate, polyvinyl alcohol, polymethacrylonitrile, polyvinyl acetate, polyvinylpyrrolidone, polycarbonate, polyethylene terephthalate, polyhexamethylene adipamide, polycaprolactam, polyurethane, polyethyleneimine, polybutadiene, polystyrene, polyisoprenes or derivatives thereof. The ion-conductive polymer can be used singly or in combination of two or more. There may further be used polymers containing various types of monomer units constituting the above polymers.

The electrolyte solution can be prepared by mixing the above electrolyte solvents and electrolyte additive. In one aspect, the electrolyte solution for a secondary battery can be prepared by a production method comprising a step of mixing at least one selected from the open chain sulfone compounds represented by formula (1) and at least one from the fluorine-containing ether compounds represented by formula (2) to prepare an electrolyte solvent in which the content of the open chain sulfone compound is more than 10 vol % and less than 70 vol %, and the content of the fluorine containing ether compound is 30 vol % or more and 90 vol % or less; a step of further adding a supporting salt to the electrolyte solvent; and a step of further adding an acid anhydride compound to the electrolyte solvent such that the content in the electrolyte solution is 0.1 mass % or more and 10 mass % or less.

### <Secondary Battery>

A secondary battery can be made using the electrolyte solution for a secondary battery according to the present invention. Herein, embodiments of a lithium ion secondary battery will be described below as an example of the battery using the electrolyte solution for a battery according to the present invention. However, the present invention is not limited to such embodiments, and the electrolyte solution for a battery according to the present invention can be applied to other various secondary batteries.

### (Positive Electrode)

A positive electrode active material is bound to a positive electrode current collector by a positive electrode binder to constitute a positive electrode. The positive electrode active material is not especially limited, but examples thereof include spinel-based materials, layered materials and olivine-based materials.

As the spinel-based material,

LiMn₂O₄;
materials operating around 4V versus lithium obtainable by substituting part of Mn of LiMn₂O₄ to increase life, for example,

LiMn₂₋ₓMₓO₄

(0<x<0.3, and M is a metal element and comprises at least one selected from Li, Al, B, Mg, Si and transition metals.);
materials that operate at high voltage of around 5 V, such as LiNi_{0.5}Mn_{1.5}O₄;
materials operating at high voltage and having a similar composition to LiNi_{0.5}Mn_{1.5}O₄, obtainable by substituting part of a constituent element of LiMn₂O₄ with a transition metal, and these further comprising another element, for example,

Liₐ(MₓMn_{2-x-y}Y_{y})(O_{4-w}Z_{w}) (7)

(0.4≤x≤1.2, 0≤y, x+y<2, 0≤a≤1.2, 0≤w≤1, M is a transition metal element and comprises at least one selected from the group consisting of Co, Ni, Fe, Cr and Cu, Y is a metal element and comprises at least one selected from the group consisting of Li, B, Na, Al, Mg, Ti, Si, K and Ca, and Z is at least one selected from the group consisting of F and Cl.), and the like may be used.

In formula (7), M comprises a transition metal element(s) selected from the group consisting of Co, Ni, Fe, Cr and Cu, and the content of these metal elements in compositional ratio x is preferably 80% or more, more preferably 90% or more, and may be 100%. Y comprises a metal element(s) selected from the group consisting of Li, B, Na, Al, Mg, Ti, Si, K and Ca, and the content of these metal elements in compositional ratio y is preferably 80% or more, more preferably 90% or more, and may be 100%.

The layered material is represented by the general formula, LiMO₂ (M is a metal element), and specific examples include lithium metal composite oxides having a layered structure represented by:

LiCo₁₋ₓMₓO₂ (0≤x<0.3, and M is a metal other than Co.),

Li_{y}Ni₁₋ₓMₓO₂ (8)

(0≤x<0.8, 0<y≤1.0 and M is at least one element selected from Co, Al, Mn, Fe, Ti and B.), in particular,

LiNi₁₋ₓMₓO₂ (0.05<x<0.3, and M is a metal element comprising at least one selected from Co, Mn and Al.), or

Li(LiₓM_{1-x-z}Mn_{z})O₂ (9)

(0.1≤x<0.3, 0.33≤z≤0.8, and M is at least one of Co and Ni.).

It is preferred that the content of Ni is high, that is, x is less than 0.5, further preferably 0.4 or less in the formula (8). Examples of such compounds include Li_{α}Ni_{β}Co_{γ}Mn_{δ}O₂ (1≤α≤1.2, β+γ+δ=1, β≥0.6, and γ≤0.2) and Li_{α}Ni_{β}Co_{γ}Al_{δ}O₂ (1≤α≤1.2, β+γ+δ=1, β≥0.6, and γ≤0.2) and particularly include LiNi_{β}Co_{γ}Mn_{δ}O₂ (0.75≤β≤0.85, 0.05≤γ≤0.15, and 0.10≤δ≤0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, LiNi_{0.8}Co_{0.1}Al_{0.1}O₂ and LiNi_{0.6}Co_{0.2}Mn_{0.2}O₂ may be preferably used.

From the viewpoint of thermal stability, it is also preferred that the content of Ni does not exceed 0.5, that is, x is 0.5 or more in the formula (8). In addition, it is also preferred that particular transition metals do not exceed half. Examples of such compounds include LiₐNi_{β}Co_{γ}Mn_{δ}O₂ (1≤α≤1.2, β+y+δ=1, 0.2≤β≤0.5, 0.1≤γ≤0.4, and 0.1≤δ≤0.4). More specific examples may include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532), LiNi_{0.4}Mn_{0.4}Co_{0.2}O₂ (also including those in which the content of each transition metal fluctuates by about 10% in these compounds). In addition, when the Ni content is low, the crystalline stability is high in a charging state, which makes it possible to set the charging voltage to 4.35 V or higher versus the lithium standard electrode potential.

Among formula (9), Li(Li_{0.2}Ni_{0.2}Mn_{0.6})O₂, Li(Li_{0.15}Ni_{0.3}Mn_{0.55}), Li(Li_{0.15}Ni_{0.2}Co_{0.1}Mn_{0.55})O₂, Li(Li_{0.15}Ni_{0.15}Co_{0.15}Mn_{0.55})O₂, Li(Li_{0.15}Ni_{0.1}Co_{0.2}Mn_{0.55})O₂ and the like are preferred.

The olivine-type material is represented by the following formula (10).

LiMPO₄ (10)

(M is at least one of Co, Fe, Mn and Ni.)

Specifically, LiFePO₄, LiMnPO₄, LiCoPO₄, LiNiPO₄ and the like may be exemplified, and the constituent elements thereof may be substituted with another element, for example, the oxygen part thereof may be substituted with fluorine. The above LiMPO₄ comprising at least one of Co and Ni in M is a positive electrode material operating at a high potential of 4.5 V or more versus Li, and can increase battery energy density. For this reason, the compositional ratio of Co and/or Ni in M is preferably 80% or more, and materials represented by the following general formula (11) are particularly preferred.

LiMPO₄ (11)

(M is at least one of Co and Ni.)

Further, as the positive electrode active material, NASICON type, a lithium transition metal silicon composite oxide and the like may be used. The positive electrode active material may be used singly, or two or more types thereof may be used in mixture.

Among these positive electrodes, positive electrode materials operating at a high potential of 4.35 V or more versus lithium are expected to increase battery energy density. For this reason, the positive electrode active materials of general formulae (7), (8), (9) and (11) are particularly preferred.

The positive electrode active material has a specific surface area of, for example, from 0.01 to 20 m²/g, preferably from 0.05 to 15 m²/g, more preferably from 0.1 to 10 m²/g, and still more preferably from 0.15 to 8 m²/g. A specific surface area in such ranges makes it possible to adjust the area in contact with the electrolyte solution within an appropriate range. That is, a specific surface area of 0.01 m²/g or more can facilitate smooth insertion and extraction of lithium ions and further decrease the resistance. In addition, by setting a specific surface area to 8 m²/g or less, decomposition of the electrolyte solution and elution of the constituent elements of the active material can be further suppressed.

The median particle size of the lithium composite oxide is preferably from 0.01 to 50 μm and more preferably from 0.02 to 40 μm. A particle size of 0.01 μm or more can further suppress elution of the constituent elements of the active material and also further suppress deterioration due to contact with the electrolyte solution. In addition, a particle size of 50 μm or less can facilitate smooth insertion and extraction of lithium ions and further decrease the resistance. The particle size can be measured with a laser diffraction-scattering particle size distribution analyzer.

Examples of the positive electrode binder include, but not particularly limited to, polyvinylidene fluoride (PVdF), vinylidene fluoride-hexafluoropropylene copolymer, vinylidene fluoride-tetrafluoroethylene copolymer, styrene-butadiene copolymer rubber, polytetrafluoroethylene, polypropylene, polyethylene, polyimide, polyamide-imide and the like. Among these, from the viewpoints of general versatility and cost reduction, polyvinylidene fluoride is preferred. The amount of the positive electrode binder to be used is preferably 2 to 10 parts by mass based on 100 parts by mass of the positive electrode active material from the viewpoint of a trade-off relationship between “sufficient binding force” and “high energy”.

Examples of the positive electrode current collector preferably include, but are not particularly limited to, aluminum, nickel, silver, iron, chromium and alloys thereof. Examples of the shape include foil, plate, and mesh shapes.

To the positive electrode active material layer containing the positive electrode active material, a conductive assisting agent may be added for the purpose of lowering the impedance. Examples of the conductive assisting agent include carbonaceous fine particles such as graphites, carbon blacks, acetylene black.

### (Negative Electrode)

The negative electrode active material is not particularly limited. Examples thereof include carbon materials capable of absorbing and desorbing lithium ions (a), metals capable of being alloyed with lithium (b), and metal oxides capable of absorbing and desorbing lithium ions (c).

As the carbon material (a), graphite, amorphous carbon, diamond-like carbon, carbon nanotubes, or composites thereof can be used. Graphite having high crystallinity has high electrical conductivity and has excellent adhesiveness to a negative electrode current collector formed of a metal, such as copper, and excellent voltage flatness. On the other hand, in amorphous carbon having low crystallinity, the volume expansion is relatively small, and therefore, the effect of relieving the volume expansion of the entire negative electrode is large, and deterioration caused by nonuniformity, such as grain boundaries and defects, does not occur easily. The carbon material (a) can be used alone or in combination with other materials.

As the metal (b), a metal mainly composed of Al, Si, Pb, Sn, Zn, Cd, Sb, In, Bi, Ag, Ba, Ca, Hg, Pd, Pt, Te, La, and the like, or alloys comprising two or more of these, or alloys of these metals or alloys with lithium, or the like can be used. Particularly, the metal (b) preferably comprises silicon (Si). The metal (b) may be used alone or in combination with other materials.

As the metal oxide (c), silicon oxide, aluminum oxide, tin oxide, indium oxide, zinc oxide, lithium oxide, LiFe₂O₃, WO₂, MoO₂, SiO, SiO₂, CuO, SnO, SnO₂, Nb₃O₅, LiₓTi₂₋ₓO₄ (1≤x≤4/3), PbO₂, Pb₂O₅ or composites thereof can be used. Particularly, the metal oxide (c) preferably comprises silicon oxide. This is because silicon oxide is relatively stable and does not easily cause reactions with other compounds. In addition, one or two or more elements selected from nitrogen, boron, and sulfur can also be added to the metal oxide (c), for example, in an amount of 0.1 to 5% by mass. By doing this, the electrical conductivity of the metal oxide (c) is improved. The metal oxide (c) may be used alone or in combination with other materials.

In addition, the negative electrode active materials may include, for example, a metal sulfide capable of absorbing and desorbing lithium ions. Examples of the metal sulfide include SnS and FeS₂. In addition, examples of the negative electrode active material can include metal lithium, polyacene or polythiophene, or lithium nitride, such as Li₇MnN₄, Li₃FeN₂, Li_{2.5}Co_{0.5}N, or Li₃CoN.

The above negative electrode active materials may be used alone or in a mixture of two or more of these.

As these negative electrode active materials, those in a form of particles may be used, or those formed into a film by vapor-phase deposition method or the like on a current collector may be used. In terms of industrial applications, those in a form of particles are preferable.

The specific surface area of particles of these negative electrode active materials is, for example, 0.01 to 100 m²/g, preferably 0.02 to 50 m²/g, more preferably 0.05 to 30 m²/g and even more preferably 0.1 to 20 m²/g. If the specific surface area is within such a range, the contact area with the electrolytic solution can be adjusted in an appropriate range. Namely, by setting the specific surface area to 0.01 m²/g or more, smooth insertion and desorption of lithium ions proceeds easily, leading to further reduction in resistance. Further, by setting the specific surface area to 20 m²/g or less, the promotion of the decomposition of the electrolyte solution and the elution of the constituent elements from the active material can be prevented.

The negative electrode binder is not particularly limited. Examples thereof include polyvinylidene fluoride (PVdF), vinylidene fluoride-hexafluoropropylene copolymers, vinylidene fluoride-tetrafluoroethylene copolymers, styrene-butadiene copolymerized rubbers, polytetrafluoroethylene, polypropylene, polyethylene, polyimides, and polyamideimides.

The content of the negative electrode binder is preferably in the range of 0.1 to 30% by mass, more preferably 0.5 to 25% by mass, based on the total amount of the negative electrode active material and the negative electrode binder. By setting the content to 0.5% by mass or more, the adhesiveness between the active materials or between the active material and the current collector is improved, and the cycle characteristics are improved. In addition, by setting the content to 30% by mass or less, the active material ratio increases, and the negative electrode capacity can be improved.

The negative electrode current collector is not particularly limited, and aluminum, nickel, copper, silver, iron, chromium, and alloys thereof are preferred because of electrochemical stability. Examples of its shape include foil, a flat plate shape, and a mesh shape.

The negative electrode can be made by forming a negative electrode active material layer comprising a negative electrode active material and a negative electrode binder on a negative electrode current collector. Examples of the method for forming the negative electrode active material layer include a doctor blade method, a die coater method, a CVD method, and a sputtering method. It is possible to previously form a negative electrode active material layer and then form a thin film of aluminum, nickel, or an alloy thereof by a method such as vapor deposition or sputtering to provide a negative electrode current collector.

### (Separator)

The secondary battery may consist of a combination of a positive electrode, a negative electrode, a separator, and a nonaqueous electrolyte as its configuration. Examples of the separator include woven fabrics, nonwoven fabrics, porous polymer films of polyolefins, such as polyethylene and polypropylene, polyimides, porous polyvinylidene fluoride films, and the like, or ion-conducting polymer electrolyte films. These may be used alone or in combination. In addition, an aramid resin separator may be used. The aramid resin separator may be used in the form of nonwoven fabrics or microporous film.

### (Shape of Battery)

Examples of the shape of the secondary battery include a cylindrical shape, a rectangular shape, a coin type, a button type, and a laminate type. Examples of the package of the battery include stainless, iron, aluminum, titanium, or alloys thereof, or plated articles thereof. As the plating, for example, nickel plating may be used.

Examples of the laminate resin film used in the laminate type include aluminum, aluminum alloy, stainless and titanium foil. Examples of the material of the thermally bondable portion of the metal laminate resin film include thermoplastic polymer materials, such as polyethylene, polypropylene, and polyethylene terephthalate. In addition, each of the numbers of the metal laminate resin films and the metal foil layers is not limited to one and may be two or more.

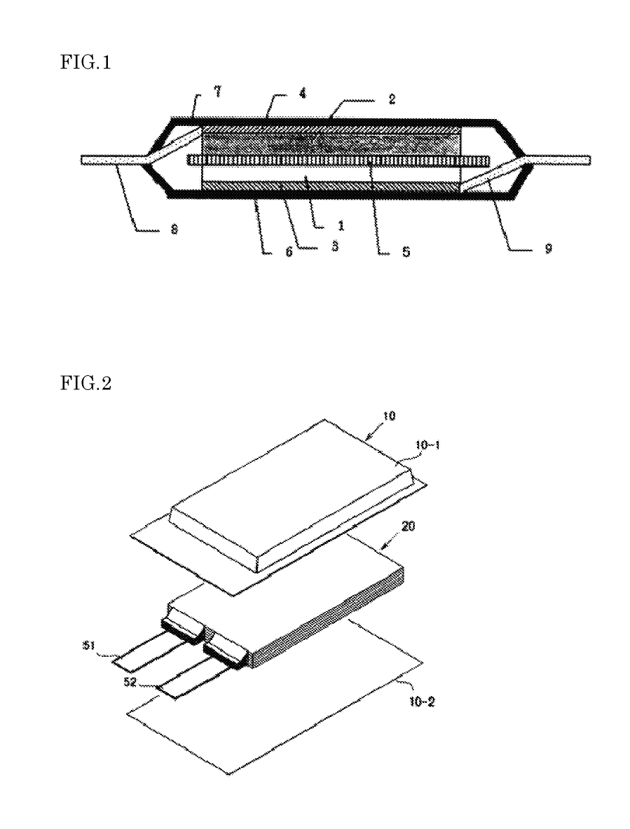

FIG. 1 shows one example of the structure of the secondary battery according to the present embodiment. The lithium secondary battery comprises a positive electrode active material layer 1 containing a positive electrode active material on a positive electrode current collector 3 formed of a metal, such as aluminum foil, and a negative electrode active material layer 2 containing a negative electrode active material on a negative electrode current collector 4 formed of a metal, such as copper foil. The positive electrode active material layer 1 and the negative electrode active material layer 2 are disposed opposed to each other via an electrolyte solution and a separator 5 formed of a nonwoven fabric, a polypropylene microporous film, or the like comprising the electrolyte solution. In FIG. 1, reference numerals 6 and 7 denote a package, reference numeral 8 denotes a negative electrode tab, and reference numeral 9 denotes a positive electrode tab.

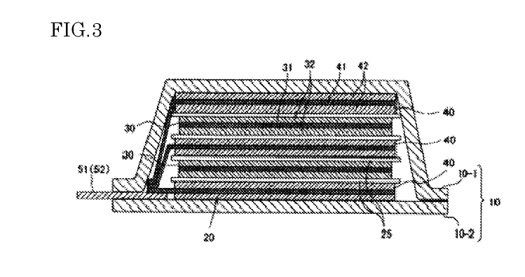

In another embodiment, the secondary battery may have a structure as shown in FIGS. 2 and 3. This lithium ion secondary battery comprises a battery element 20, a film package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 3. In the positive electrode 30, an electrode material 32 is applied to both surfaces of a metal foil 31, and also in the negative electrode 40, an electrode material 42 is applied to both surfaces of a metal foil 41 in the same manner. The present invention is not necessarily limited to stacking type batteries and may also be applied to batteries such as a winding type.

Although the electrode tabs are drawn out to both sides of the outer package in the battery of FIG. 1, the lithium ion secondary battery according to the present embodiment may have an arrangement in which the electrode tabs are drawn out to one side of the outer package as shown in FIG. 2. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 3). The portion in which the extended portions are brought together into one in the stacking direction in this manner is also referred to as a “current collecting portion” or the like.

The film package 10 is composed of two films 10-1 and 10-2 in this example. The films 10-1 and 10-2 are heat-sealed to each other in the peripheral portion of the battery element 20 and hermetically sealed. In FIG. 2, the positive electrode tab 51 and the negative electrode tab 52 are drawn out in the same direction from one short side of the film package 10 hermetically sealed in this manner.

Of course, the electrode tabs may be drawn out from different two sides respectively. In addition, regarding the arrangement of the films, in FIG. 2 and FIG. 3, an example in which a cup portion is formed in one film 10-1 and a cup portion is not formed in the other film 10-2 is shown, but other than this, an arrangement in which cup portions are formed in both films (not illustrated), an arrangement in which a cup portion is not formed in either film (not illustrated), and the like may also be adopted.

### (Method for Manufacturing Secondary Battery)

The secondary battery according to the present embodiment can be manufactured by a conventional method. An example of a method for manufacturing a secondary battery will be described taking a stacked laminate type secondary battery as an example. First, in the dry air or an inert atmosphere, the positive electrode and the negative electrode are placed to oppose to each other via a separator to form an electrode element. Next, this electrode element is accommodated in an outer package (container), an electrolyte solution is injected, and the electrodes are impregnated with the electrolyte solution. Thereafter, the opening of the outer package is sealed to complete the secondary battery.

### (Assembled Battery)

A plurality of the secondary batteries according to the present embodiment may be combined to form an assembled battery. The assembled battery may be configured by connecting two or more secondary batteries according to the present embodiment in series or in parallel or in combination of both. The connection in series and/or parallel makes it possible to adjust the capacitance and voltage freely. The number of the secondary batteries included in the assembled battery can be set appropriately according to the battery capacity and output.

### (Vehicle)

The secondary battery or the assembled battery according to the present embodiment can be used in vehicles. Vehicles according to the present embodiment include hybrid vehicles, fuel cell vehicles, electric vehicles (besides four-wheel vehicles (cars, trucks, commercial vehicles such as buses, light automobiles, etc.) two-wheeled vehicle (bike) and tricycle), and the like. The vehicle according to the present embodiment is not limited to automobiles, and it may be a variety of power source of other vehicles, such as a moving body like a train.

### EXAMPLE

Specific examples according to the present invention will be described below, but the present invention is not limited to these examples and can be carried out by making appropriate changes without departing from the spirit thereof. FIG. 1 is a schematic diagram showing the configuration of lithium secondary batteries made in these examples

### <Evaluation of Electrolyte Solution>

Polyvinylidene fluoride (4 mass %) as a binder and carbon black (4 mass %) as a conductive assisting agent were mixed with LiNi_{0.5}Mn_{1.5}O₄ as a positive electrode active material, to prepare a positive electrode mixture. The positive electrode mixture was dispersed in N-methyl-2-pyrrolidone to prepare a positive electrode slurry. One surface of a 20 μm thick aluminum current collector was uniformly coated with this positive electrode slurry. The thickness of the coating film was adjusted so that the initial charge capacity per unit area was 2.5 mAh/cm². The coated current collector was dried and then compression-shaped by a roll press to make a positive electrode.

As a negative electrode active material, artificial graphite was used. The artificial graphite was dispersed in N-methylpyrrolidone in which PVdF as a binder was dissolved, to prepare a negative electrode slurry. The mass ratio of the negative electrode active material and the binder was 95/5. A 10 μm thick Cu current collector was uniformly coated with this negative electrode slurry. The thickness of the coating film was adjusted so that the initial charge capacity per unit area was 3.0 mAh/cm². The coated current collector was dried and then compression-shaped by a roll press to make a negative electrode.

The positive electrode and the negative electrode cut into 3 cm×3 cm were disposed so as to be opposed to each other via a separator. As the separator, a 25 μm thick microporous polypropylene film was used.

The above positive electrode, negative electrode and separator, and an electrolyte solution were disposed in a laminate package, and the laminate was sealed to make a lithium secondary battery. The positive electrode and the negative electrode were brought into a state in which tabs were connected and the positive electrode and the negative electrode were electrically connected from the outside of the laminate.

Diethyl sulfone (DES), ethyl methyl sulfone (EMS), methyl isopropyl sulfone (MiPS), ethyl isopropyl sulfone (EiPS), sulfolane (SL), 1,2,2,2-tetrafluoroethyl-2,2,3,3-tetrafluoropropyl ether (FE1), 1H,1H,2′H,3H-decafluorodipropyl ether (FE2), bis(2,2,3,3-tetrafluoropropyl) ether (FE3), diethyl carbonate (DEC), and ethylene carbonate (EC) were used as electrolyte solvents. In preparing the electrolyte solution, the volume ratio was determined by converting mass with the following density of the solvents at room temperature. FE1: 1.53 g/cc, FE2: 1.57 g/cc, FE3: 1.63 g/cc, DES: 1.36 g/cc, EMS: 1.09 g/cc, MiPS: 1.13 g/cc, EiPS: 1.09 g/cc, SL: 1.26 g/cc, EC: 1.32 g/cc, DEC: 0.97 g/cc. DES alone is solid at room temperature, and the volume ratio was determined using the solid density (1.36 g/cc). LiPF₆ was added in an amount of 0.8 mol/L based on the total volume of the mixed solvent, to prepare an electrolyte solution. The amount of LiPF₆ was 1 mol/L only in the case of EC/DEC=30/70.

Maleic anhydride (MA), 3H-perfluoropropionic anhydride (A1), 3,3,3-trifluoropropionic anhydride (A2), hexafluoroglutaric anhydride (A3) were used as acid anhydrides. The acid anhydride was added such that the mass ratio of the acid anhydride to the electrolyte solution was as shown in Table 1 to prepare an electrolyte solution.

The electrolytic solution was stirred at 45° C. for 2 hours and left to stand at room temperature for 1 day, and then the state was visually observed. At this time, when a precipitate was generated or when the electrolyte solution separated into two phases, the homogeneous mixability was judged as “x”, and when the electrolyte solution was homogenous and transparent, the homogeneous mixability was judged as “∘”. The results were shown in Table 1. When the electrolyte solution could be homogeneously mixed, a lithium secondary battery was completed by pouring it into a laminate type lithium secondary battery and then sealing it in a vacuum. When the electrolyte solution could not be homogeneously mixed, evaluation of cycle characteristics and the like was not conducted.

The fabricated battery was charged at 20 mA, and after the voltage reached the upper limit of 4.75 V, the battery was charged at constant voltage until the total charge time reached 2.5 hours. Then the battery was discharged at 20 mA at constant current until the voltage reached the lower limit of 3 V. This charge/discharge was repeated 100 times. The cell was disposed in a thermostat chamber at 45° C. to be charged and discharged. The ratio of the capacity at the 100^{th} cycle to the capacity at the 1st cycle (capacity retention ratio after 100 cycles at 45° C.) was evaluated. The results thereof are shown in Table 1.

TABLE 1

| | | | Homo- | Capac- |
|---|---|---|---|---|
| | Solvent | Type and | geneous | ity re- |
| | composition | amount of | mixa- | tention |
| | (volume ratio) | additive | bility | ratio |
| Comparative | EC/DEC = 30/70 | None | ∘ | 59% |
| example 1 | | | | |
| Comparative | EC/DEC = 30/70 | MA, 1 mass % | ∘ | 62% |
| example 2 | | | | |
| Comparative | DES/FE1 = 10/90 | None | x | — |
| example 3 | | | | |
| Comparative | DES/FE1 = 20/80 | None | ∘ | 52% |
| example 4 | | | | |
| Example 1 | DES/FE1 = 20/80 | MA, 1 mass % | ∘ | 71% |
| Comparative | DES/FE1 = 30/70 | None | ∘ | 56% |
| example 5 | | | | |
| Example 2 | DES/FE1 = 30/70 | A1, 1 mass % | ∘ | 82% |
| Example 3 | DES/FE1 = 30/70 | MA, 1 mass % | ∘ | 85% |
| Example 4 | DES/FE1 = 30/70 | A2, 1 mass % | ∘ | 84% |
| Example 5 | DES/FE1 = 30/70 | A3, 1 mass % | ∘ | 83% |
| Comparative | DES/FE1 = 40/60 | None | ∘ | 54% |
| example 6 | | | | |
| Example 6 | DES/FE1 = 40/60 | MA, 1 mass % | ∘ | 81% |
| Comparative | DES/FE1 = 70/30 | None | x | — |
| example 7 | | | | |
| Comparative | DES/FE2 = 30/70 | None | ∘ | 49% |
| example 8 | | | | |
| Example 7 | DES/FE2 = 30/70 | A1, 1 mass % | ∘ | 81% |
| Comparative | DES/FE3 = 30/70 | None | ∘ | 58% |
| example 9 | | | | |
| Example 8 | DES/FE3 = 30/70 | A1, 1 mass % | ∘ | 82% |
| Comparative | EiPS/FE1 = 40/60 | None | ∘ | 63% |
| example 10 | | | | |
| Example 9 | EiPS/FE1 = 40/60 | MA, 1 mass % | ∘ | 79% |
| Comparative | EiPS/FE1 = 60/40 | None | ∘ | 60% |
| example 11 | | | | |
| Example 10 | EiPS/FE1 = 60/40 | A1, 1 mass % | ∘ | 78% |
| Comparative | MiPS/FE1 = 40/60 | None | ∘ | 58% |
| example 12 | | | | |
| Example 11 | MiPS/FE1 = 40/60 | A3, 1 mass % | ∘ | 79% |
| Comparative | EMS/FE1 = 40/60 | None | ∘ | 46% |
| example 13 | | | | |
| Example 12 | EMS/FE1 = 40/60 | A2, 1 mass % | ∘ | 77% |
| Comparative | SL/FE1 = 50/50 | MA, 1 mass % | ∘ | 64% |
| example 14 | | | | |
| Example 13 | DES/FE1 = 30/70 | A1, 0.1 mass % | ∘ | 65% |
| Example 14 | DES/FE1 = 30/70 | A1, 0.2 mass % | ∘ | 69% |
| Example 15 | DES/FE1 = 30/70 | A1, 0.5 mass % | ∘ | 73% |
| Example 16 | DES/FE1 = 30/70 | A1, 2 mass % | ∘ | 84% |
| Example 17 | DES/FE1 = 30/70 | A1, 3 mass % | ∘ | 82% |
| Example 18 | DES/FE1 = 30/70 | A1, 5 mass % | ∘ | 79% |
| Example 19 | DES/FE1 = 30/70 | A1, 8 mass % | ∘ | 72% |
| Example 20 | DES/FE1 = 30/70 | A1, 10 mass % | ∘ | 66% |

The electrolyte solution using the solvent of EC/DEC=30/70 resulted in low capacity retention ratio as shown in Comparative examples 1 and 2 of Table 1. This is conceivably because the oxidation resistance of the electrolyte solvent was low. Compared with Comparative examples 4, 5 and 6, Examples 1, 2, 3, 4, 5 and 6 using an acid anhydride showed high capacity retention ratio after cycle evaluation. This is conceivably because the acid anhydride in the electrolyte solution containing the sulfone compound and the fluorine-containing ether compound formed a reaction product on an electrode, and suppressed a decomposition reaction of the electrolyte solvent during the cycles at high temperature.

Evaluation results of various fluorine-containing ether compounds are shown in Comparative Examples 8 and 9 and Examples 7 and 8. In any case, the capacity retention ratio was increased by adding an acid anhydride, and the same effect was obtained.

Evaluation results of various sulfone compounds are shown in Comparative examples 10 to 13 and Examples 9 to 12. Also in the case of EiPS, MiPS, and EMS, the capacity retention ratio was increased by adding an acid anhydride, and the same effect was obtained. As show in Comparative example 14, when sulfolane (SL) that is a cyclic sulfone compound was used, the capacity retention ratio was lower than when an open chain sulfone compound was used (for example, Examples 9 to 12). Thus, among sulfone compounds, open chain sulfone compounds are considered to be more effective than cyclic sulfone compounds.

With respect to the content of the open chain sulfone compound, a precipitation was observed when the content of DES was 70 vol % as in Comparative example 7. On the other hand, uniform mixture could not be also obtained when the content of DES was 10 vol % as in Comparative Example 3. It is considered that the composition ratio of the sulfone compound is preferably more than 10 vol % and less than 70 vol %. With respect to the fluorine-containing ether compound, the content is preferably 30 vol % or more and 90 vol % or less. When the content of the sulfone compound was 60 vol % as in Example 10, good characteristics were obtained. From such a result, the content of the sulfone compound is more preferably 20 vol % or more and 60 vol % or less, and the content of the fluorine-containing ether compound is preferably 40 vol % or more and 80 vol % or less.

The addition amount of the acid anhydride was changed and evaluated, and the results are shown in Examples 2 and 13 to 20. From these results, the mass ratio of the acid anhydride in the electrolyte solution is preferably 0.1 mass % or more and 10 mass % or less, more preferably 0.2 mass % or more and 8 mass % or less, and further more preferably 0.5 mass % or more and 5 mass % or less.

### <Evaluation of Various Positive and Negative Electrode Materials>

Subsequently, the positive electrode material and the negative electrode material were changed and the evaluation was carried out. 5V class spinel type LiNi_{0.5}Mn_{1.3}Ti_{0.2}O₄, layered type LiNi_{0.5}Co_{0.2}Mn_{0.3}O₂, Li excess layered type Li(Li_{0.2}Ni_{0.2}Mn_{0.6})O₂ and olivine type LiCoPO₄ were used as positive electrode materials in the evaluation. Graphite, SiO and Si alloy were used in the negative electrodes. The SiO was composite particles of Si and SiO₂, the surface of which was coated with carbon, and the mass ratio of the Si compound to the carbon on the surface was 95/5. The SiO was dispersed in N-methylpyrrolidone in which a polyimide binder was dissolved, to prepare a negative electrode slurry. The mass ratio of the negative electrode active material to the binder was 85/15. The thickness of the coating film was adjusted so that the initial charge capacity per unit area was 3.0 mAh/cm², to produce a negative electrode. The Si alloy was an alloy of Si and Sn, in which the mass ratio Si/Sn was 60/40. The negative electrode using the Si alloy as an active material was produced under the same conditions as that using SiO. The positive electrode and the negative electrode were produced under the same conditions as in Example 1.

Three kinds of electrolyte solutions were compared and evaluated. Electrolyte solution 1 was 0.8 mol/l-LiPF₆ DES/FE1=30/70 (volume ratio), Electrolyte solution 2 was 1 mol/l-LiPF₆ EC/DEC=30/70 (volume ratio) containing A1 in an amount of 1 mass %, and Electrolyte solution 3 was 0.8 mol/l-LiPF₆ DES/FE1=30/70 (volume ratio) containing A1 in an amount of 1 mass %. Charging voltage and discharging voltage in the evaluation of cycle characteristics were selected according to the combination of the positive and negative electrode materials. Ranges of the charge voltage and the discharge voltage are shown in the table. The results of the capacity retention ratio after 100 cycles at 45° C. are shown in Table 2.

TABLE 2

| | | Negative | | Operating | Capacity |
|---|---|---|---|---|---|
| | Positive electrode | electrode | Electrolyte | voltage | retention |
| | material | material | solution | range | ratio |
| Comparative | LiNi_{0.5}Mn_{1.3}Ti_{0.2}O₄ | Graphite | 1 | 4.75 to 3 V | 52% |
| example 15 | | | | | |
| Comparative | LiNi_{0.5}Mn_{1.3}Ti_{0.2}O₄ | Graphite | 2 | 4.75 to 3 V | 63% |
| example 16 | | | | | |
| Example 21 | LiNi_{0.5}Mn_{1.3}Ti_{0.2}O₄ | Graphite | 3 | 4.75 to 3 V | 86% |
| Comparative | LiNi_{0.5}Co_{0.2}Mn_{0.3}O₂ | Graphite | 1 | 4.35 to 3 V | 72% |
| example 17 | | | | | |
| Comparative | LiNi_{0.5}Co_{0.2}Mn_{0.3}O₂ | Graphite | 2 | 4.35 to 3 V | 78% |
| example 18 | | | | | |
| Example 22 | LiNi_{0.5}Co_{0.2}Mn_{0.3}O₂ | Graphite | 3 | 4.35 to 3 V | 88% |
| Comparative | Li(Li_{0.2}Ni_{0.2}Mn_{0.6})O₂ | SiO | 1 | 4.5 to 2 V | 56% |
| example 19 | | | | | |
| Comparative | Li(Li_{0.2}Ni_{0.2}Mn_{0.6})O₂ | SiO | 2 | 4.5 to 2 V | 64% |
| example 20 | | | | | |
| Example 23 | Li(Li_{0.2}Ni_{0.2}Mn_{0.6})O₂ | SiO | 3 | 4.5 to 2 V | 81% |
| Comparative | Li(Li_{0.2}Ni_{0.2}Mn_{0.6})O₂ | Si alloy | 1 | 4.5 to 2 V | 43% |
| example 21 | | | | | |
| Comparative | Li(Li_{0.2}Ni_{0.2}Mn_{0.6})O₂ | Si alloy | 2 | 4.5 to 2 V | 52% |
| example 22 | | | | | |
| Example 24 | Li(Li_{0.2}Ni_{0.2}Mn_{0.6})O₂ | Si alloy | 3 | 4.5 to 2 V | 76% |
| Comparative | LiCoPO₄ | Graphite | 1 | 4.8 to 3 V | 46% |
| example 23 | | | | | |
| Comparative | LiCoPO₄ | Graphite | 2 | 4.8 to 3 V | 52% |
| example 24 | | | | | |
| Example 25 | LiCoPO₄ | Graphite | 3 | 4.8 to 3 V | 76% |

As shown in Table 2, when the charging voltage was high, the improvement effect of Electrolyte solution 3 (0.8 mol/l-LiPF₆ DES/FE1=30/70 (volume ratio) containing A1 in an amount of 1 mass %) was especially large. In this way, when a positive electrode material operates at 4.35 V or more versus the lithium standard electrode potential, the effect of the electrolyte solution according to the present invention becomes high. In particular, the improvement effect was larger as the charge voltage and the operating potential of the positive electrode were higher. This is conceivably because the oxidation resistance of the electrolytic solution of the present invention was high, and the improvement effect due to the acid anhydride was large. In Example 22, the potential of the negative electrode graphite is about 0.03 V versus the lithium standard electrode potential when the battery is in a charging state. Therefore, when the battery is in a charging state of 4.35 V, the positive electrode potential is 4.35 V or more versus the lithium standard electrode potential.

Subsequently, an electrolyte solution comprising an acid anhydride was evaluated in a cell using Li(Li_{0.15}Ni_{0.32}Mn_{0.53})O₂ as a positive electrode active material and SiO as a negative electrode active material. The SiO was composite particles of Si and SiO₂, the surface of which was coated with carbon, and the mass ratio of the Si compound and the carbon on the surface was 95/5. The SiO was dispersed in N-methylpyrrolidone in which a polyimide binder was dissolved, to prepare a negative electrode slurry. The mass ratio of the negative electrode active material and the binder was 85/15. The thickness of the coating film was adjusted so that the initial charge capacity per unit area was 3.0 mAh/cm², to produce a negative electrode. The positive electrode and the cell were produced under the same conditions as in Example 1.

A base electrolyte solution, 0.9 mol/l-LiPF₆ DES/FE1=40/60 (volume ratio), was prepared, and electrolyte solutions were prepared by adding 1 mass % of an acid anhydride shown below to this base electrolyte solution.

As the acid anhydrides, maleic anhydride (MA), 3,3,3-trifluoropropionic anhydride (A2), hexafluoroglutaric anhydride (A3) and difluoroacetic anhydride (A4) were used. These electrolyte solutions were poured into the fabricated cells to prepare batteries for evaluation.

The fabricated battery was charged at 12 mA, and after the voltage reached the upper limit voltage of 4.5 V, the battery was charged at constant voltage until the charging current amount reached 2.4 mA. Then the battery was discharged at 12 mA at constant current until the voltage reached the lower limit voltage of 1.5 V, next, discharged at 6 mA at constant current until the voltage reached the lower limit voltage of 1.5 V, and next, discharged at 2.4 mA at constant current until the voltage reached the lower limit voltage of 1.5 V. This charge/discharge cycle was repeated 150 times. The ratio of the integrated value of discharge capacity at the 150th cycle in which discharge was conducted at 12 mA, 6 mA and 2.4 mA to the integrated value of discharge capacity at the first cycle in which discharge was conducted at 12 mA, 6 mA and 2.4 mA was evaluated as capacity retention ratio at 45° C. after 150 cycles. The results are shown in Table 3.

TABLE 3

| | Electrolyte additive | Capacity retention |
|---|---|---|
| | type | ratio |
| Comparative | None | 40% |
| example 25 | | |
| Example 26 | MA | 80% |
| Example 27 | A2 | 76% |
| Example 28 | A3 | 80% |
| Example 29 | A4 | 78% |

As described above, by using the electrolytic solution of the present embodiment, an effect of improving the life of a lithium ion battery operating at high voltage was obtained. This makes it possible to provide a lithium secondary battery with a long life.

This application claims priority right based on Japanese patent application No. 2016-006403, filed on Jan. 15, 2016, and Japanese patent application No. 2016-180385, filed on Sep. 15, 2016, the entire disclosure of which is hereby incorporated by reference.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### EXPLANATION OF REFERENCE

1 positive electrode active material layer
2 negative electrode active material layer
3 positive electrode current collector
4 negative electrode current collector
5 separator
6 laminate package
7 laminate package
8 negative electrode tab
9 positive electrode tab
10 film package
20 battery element
25 separator
30 positive electrode
40 negative electrode

1. An electrolyte solution for a secondary battery comprising
an electrolyte solvent comprising at least one selected from open chain sulfone compounds represented by formula (1) and at least one selected from fluorine-containing ether compounds represented by formula (2), and
at least one selected from acid anhydride compounds,
wherein a content of the open chain sulfone compound represented by formula (1) in the electrolyte solvent is more than 10 vol % and less than 70 vol %,
a content of the fluorine-containing ether compound represented by formula (2) in the electrolyte solvent is 30 vol % or more and 90 vol % or less, and
a content of the acid anhydride compound in the electrolyte solution is 0.1 mass % or more and 10 mass % or less,
R₁″—SO₂—R₂″ (1)
wherein R₁″ and R₂″ each independently represent substituted or unsubstituted alkyl group having 1 to 6 carbon atoms, and
R₁—O—R₂ (2)
wherein R₁ and R₂ each independently represent alkyl group having 1 to 7 carbon atoms, and at least one of R₁ and R₂ is fluorine-containing alkyl group.

2. The electrolyte solution for a secondary battery according to claim 1, wherein a total volume ratio of the open chain sulfone compound represented by formula (1) and the fluorine-containing ether compound represented by formula (2) in the electrolyte solvent is 80 vol % or more.

3. The electrolyte solution for a secondary battery according to claim 1, wherein the open chain sulfone compound represented by formula (1) is at least one selected from dimethyl sulfone, ethyl methyl sulfone, diethyl sulfone, methyl isopropyl sulfone, and ethyl isopropyl sulfone.

4. The electrolyte solution for a secondary battery according to claim 1, wherein the fluorine-containing ether compound represented by formula (2) is at least one selected from 1,1,2,2-tetrafluoroethyl-2,2,3,3-tetrafluoropropyl ether, 2,2,3,4,4,4-hexafluorobutyl-difluoromethyl ether, 1,1-difluoroethyl-2,2,3,3-tetrafluoropropyl ether, 1,1,2,3,3,3-hexafluoropropyl-2,2-difluoroethyl ether, 1,1-difluoroethyl-1H,1H-heptafluorobutyl ether, 1H,1H,2′H,3H-decafluorodipropyl ether, bis(2,2,3,3,3-pentafluoropropyl) ether, 1H,1H,5H-perfluoropentyl-1,1,2,2-tetrafluoroethyl ether, bis(1H,1H-heptafluorobutyl) ether, 1H,1H,2′H-perfluorodipropyl ether, 1,1,2,3,3,3-hexafluoropropyl-1H,1H-heptafluorobutyl ether, and 1H-perfluorobutyl-1H-perfluoroethyl ether, bis(2,2,3,3-tetrafluoropropyl) ether.

5. The electrolyte solution for a secondary battery according to claim 1, wherein the acid anhydride compound is a carboxylic acid anhydride having a structure: [—(C═O)—O—(C═O)—].

6. The electrolyte solution for a secondary battery according to claim 1, wherein the acid anhydride compound is a compound represented by formula (7) or (8), 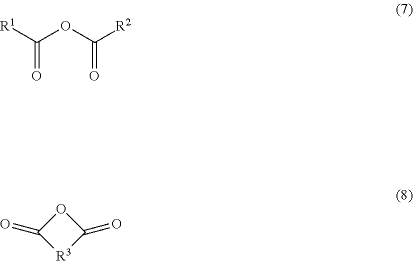
wherein R¹, R² and R³ are alkyl group or alkenyl group having 1 to 5 carbon atoms, and at least one of hydrogen atoms in R¹, R² and R³ may be substituted with a fluorine atom.

7. The electrolyte solution for a secondary battery according to claim 1, wherein the acid anhydride compound comprises a hydrocarbon group in which a part or all of hydrogen atoms is replaced with a halogen atom.

8. The electrolyte solution for a secondary battery according to claim 1, wherein the acid anhydride compound is at least one acid anhydride selected from acetic anhydride, maleic anhydride, phthalic anhydride, propionic anhydride, succinic anhydride, benzoic anhydride, glutaric anhydride, difluoroacetic anhydride, 3H-perfluoropropionic anhydride, 3,3,3-trifluoropropionic anhydride, pentafluoropropionic anhydride, 2,2,3,3,4,4-hexafluoropentanedioic anhydride, tetrafluorosuccinic anhydride, trifluoroacetic anhydride, hexafluoroglutaric anhydride and 4-methylphthalic anhydride.

9. A secondary battery comprising the electrolyte solution for a secondary battery according to claim 1.

10. The secondary battery according to claim 9, comprising a positive electrode comprising a positive electrode active material inserting and desorbing Li at 4.35 V or more versus a standard electrode potential of Li.

11. The secondary battery according to claim 9, comprising a positive electrode comprising at least one positive electrode active material selected from lithium metal composite oxides represented by formulae (3) to (6),
Liₐ(MₓMn_{2-x-y}Y_{y})(O_{4-w}Z_{w}) (3)
wherein 0.4≤x≤1.2, 0≤y, x+y<2, 0≤a≤1.2, 0≤w≤1, M is a transition metal and comprises at least one selected from the group consisting of Co, Ni, Fe, Cr and Cu, Y is at least one selected from the group consisting of Li, B, Na, Al, Mg, Ti, Si, K and Ca, and Z is at least one of F and Cl,
Li_{y}Ni₁₋ₓMₓO₂ (4)
wherein, 0≤x<0.8, 0<y≤1.0 and M is at least one element selected from the group consisting of Co, Al, Mn, Fe, Ti and B,
Li(LiₓM_{1-x-z}Mn_{z})O₂ (5)
wherein, 0.1≤x<0.3, 0.33≤z≤0.8, and M is at least one of Co and Ni, and
LiMPO₄ (6)
wherein, M is at least one of Co and Ni.

12. The secondary battery according to claim 9, comprising at least one negative electrode active material selected from graphite, Si oxides, and Si alloys.

13. (canceled)

14. A method of producing an electrolyte solution for a secondary battery, comprising the steps of
mixing at least one selected from open chain sulfone compounds represented by formula (1) and at least one selected from fluorine-containing ether compounds represented by formula (2) to prepare an electrolyte solvent in which a content of the open chain sulfone compound represented by formula (1) is more than 10 vol % and less than 70 vol %, and a content of the fluorine-containing ether compound represented by formula (2) is 30 vol % or more and 90 vol % or less,
adding a supporting salt to the electrolyte solvent, and
adding an acid anhydride compound such that a content of the acid anhydride compound in the electrolyte solution is 0.1 mass % or more and 10 mass % or less,
R₁″—SO₂—R₂″ (1)
wherein R₁″ and R₂″ each independently represent substituted or unsubstituted alkyl group having 1 to 6 carbon atoms, and
R₁—O—R₂ (2)
wherein R₁ and R₂ each independently represent alkyl group having 1 to 7 carbon atoms, and at least one of R₁ and R₂ is fluorine-containing alkyl group.
